(19) United States
(12) Patent Application Publication
(10) Pub. No.: US 2009/0057374 A1
(43) Pub. Date: Mar. 5, 2009

(54) HOT-BAR SOLDERING TOOL HEAD

(76) Inventors: Kun-Tsung Chen, Taichung City (TW); Hsun-Fa Li, Nan-Tou Hsien (TW); Yu-Hung Shih, Nan-Tou City (TW)

Correspondence Address: OSTROLENK FABER GERB & SOFFEN, 1180 AVENUE OF THE AMERICAS, NEW YORK, NY, 100368403, US

(21) Appl. No.: 11/848,361

(22) Filed: Aug. 31, 2007

(51) Int. Cl. B23K 3/02

(52) U.S. Cl. 228/51

(57) ABSTRACT

A hot-bar head is adapted for soldering at least two flexible flat cables to a substrate. The hot-bar head includes a head body having a connecting portion that extends in a longitudinal direction, and at least two soldering portions, each of which extends from the connecting portion and has a blade edge adapted for contacting one of the flexible flat cables. Adjacent ones of the soldering portions are spaced apart from each other in the longitudinal direction.

### BACKGROUND OF THE INVENTION

1. Field of the Invention

The invention relates to a hot-bar soldering tool for soldering flexible flat cables to a substrate.

2. Description of the Related Art

FIG. 1 illustrates a conventional hot-bar head 1 for soldering a flexible flat cable 21 to a contact region 201 of a substrate 20 so as to establish electrical connection between the flexible flat cable 21 and the substrate 20.

Since the width of the conventional hot-bar head 1 is only slightly wider than the width of the flexible flat cable 21, the conventional hot-bar head 1 can be used to solder only one flexible flat cable 21 to the substrate 20 in a single hot-bar soldering operation.

FIG. 2 illustrates a screen control board, such as a X-board or a Y-board found in large television sets or display devices, that requires soldering of two flexible flat cables 21, 22 to a substrate 20. Since the conventional head 1 can only be used to solder one flexible flat cable 21 at a time, two hot-bar soldering operations are needed to assemble the flexible flat cables 21, 22 to the substrate 20, thereby affecting adversely the production rate.

### SUMMARY OF THE INVENTION

Therefore, it is an object of the present invention to provide a hot-bar soldering tool head that can be used to solder more than one flexible flat cable to a substrate in a single hot-bar soldering operation so as to increase the production rate.

Accordingly, a hot-bar head of the present invention is adapted for soldering at least two flexible flat cables to a substrate. The hot-bar head includes a head body having a connecting portion that extends in a longitudinal direction, and at least two soldering portions, each of which extends from the connecting portion and has a blade edge adapted for contacting one of the flexible flat cables. Adjacent ones of the soldering portions are spaced apart from each other in the longitudinal direction. Because of the at least two soldering portions, at least two flexible flat cables can be soldered to a substrate in a single hot-bar soldering portion, thereby increasing the production rate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional hot-bar head for soldering a flexible flat cable to a substrate;

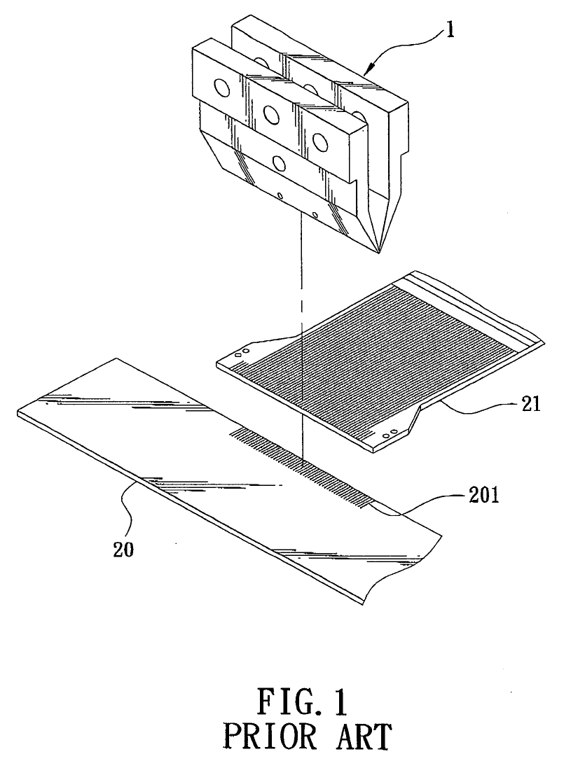

FIG. 2 is a schematic view of a conventional screen control board having two flexible flat cables soldered to substrate;

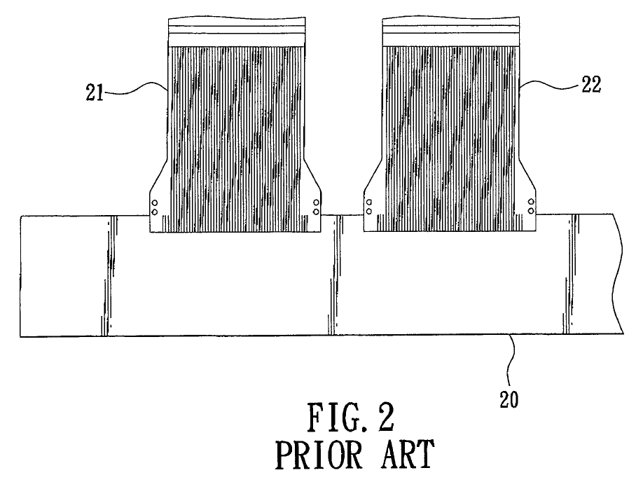

FIG. 3 is an exploded perspective view showing the preferred embodiment of a hot-bar head according to the present invention for soldering two flexible flat cables to a substrate;

FIG. 4 is a perspective view showing the preferred embodiment in a state of use; and

FIG. 5 is a sectional view showing the preferred embodiment in the state of use.

### DETAILED DESCRIPTION OF THE PREFERRED EMBODIMENT

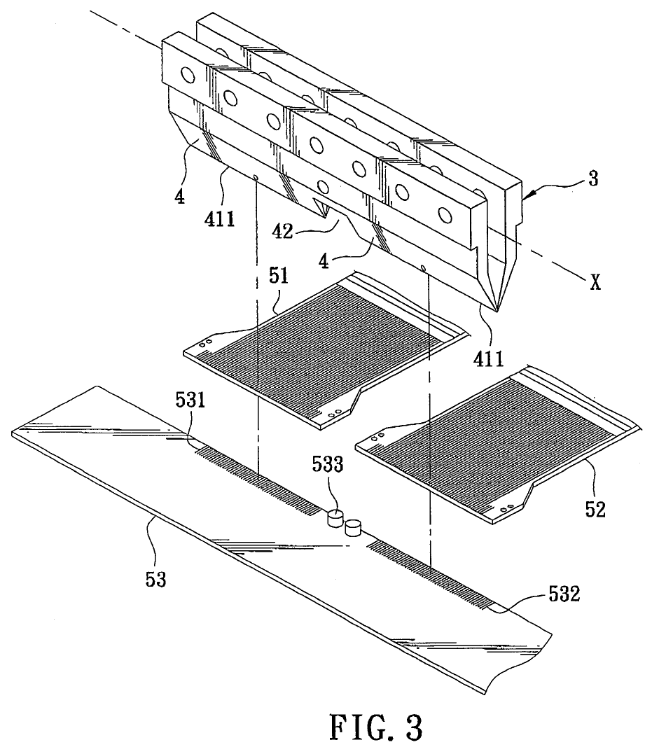

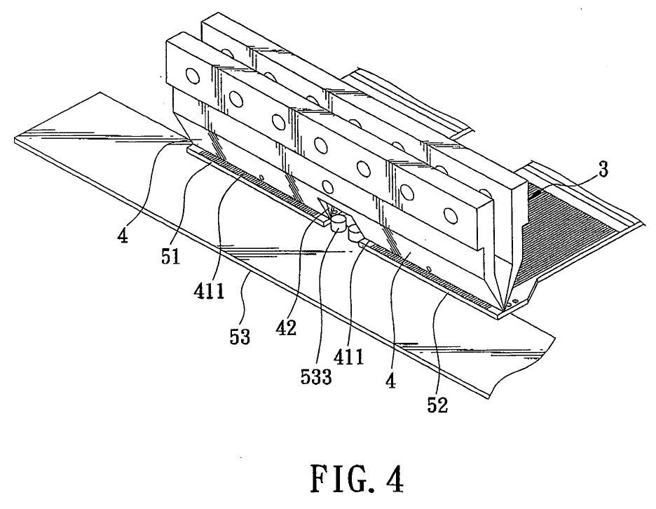

Referring to FIGS. 3 and 4, the preferred embodiment of a hot-bar head according to the present invention is adapted to be installed on a hot-bar soldering machine (not shown), and includes a head body having a connecting portion 3 and two soldering portions 4.

The connecting portion 3 extends in a longitudinal direction (X). Each of the soldering portions 4 extends integrally from the connection portion 3, and has a blade edge 411. The soldering portions 4 are spaced apart from each other in the longitudinal direction (X) to form a notch 42 therebetween.

In use, heat is conducted to the hot-bar head, and the blade edges 411 of the soldering portions 4 are brought into contact with a pair of flexible flat cables 51, 52, respectively, to solder the flexible flat cables 51, 52 to corresponding contact regions 531, 532 of a substrate 53, thereby establishing electrical connection between the flexible flat cables 51, 52 and the substrate 53 in a single hot-bar soldering operation, which takes about 30 seconds to complete.

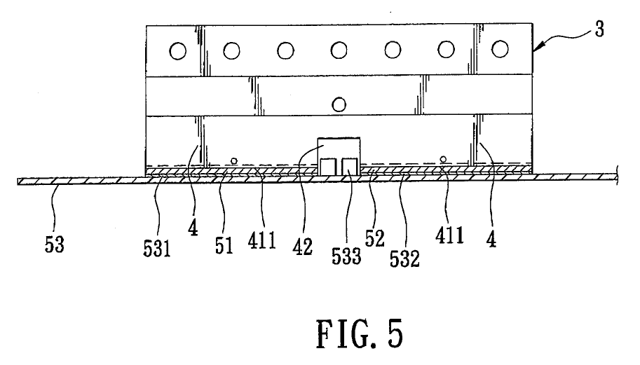

Referring to FIG. 5, the soldering portions 4 are spaced apart from each other in the longitudinal direction (X) to form the notch 42 therebetween. Components 533 (capacitors, transistor, etc) on the substrate 53 can be received in the notch 42 so as to prevent the hot-bar head from damaging components 533 during the hot-bar soldering operation.

It should be noted herein that the number of the soldering portions 4 of the head body of the hot-bar soldering tool head may be more than two in other embodiments of this invention.

Due to the presence of at least two soldering portions 4, the hot-bar soldering tool head of this invention permits at least two flexible flat cables 51, 52 to be soldered to a substrate 53 in a single hot-bar soldering operation, thereby increasing the production rate.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A hot-bar head adapted for soldering at least two flexible flat cables to a substrate, said hot-bar head comprising:
a head body having a connecting portion that extends in a longitudinal direction, and at least two soldering portions, each of which extends from said connecting portion and has a blade edge adapted for contacting one of the flexible flat cables, adjacent ones of said soldering portions being spaced apart from each other in the longitudinal direction.

2. The hot-bar head as claimed in claim 1, wherein said head body further has at least one notch disposed between a corresponding adjacent pair of said soldering portions.

3. The hot-bar head as claimed in claim 2, wherein each of said soldering portions extends integrally from said connecting portion.
